(19) United States
(12) Patent Application Publication
(10) Pub. No.: US 2007/0188093 A1
(43) Pub. Date: Aug. 16, 2007

(54) Organic electroluminescent display panel

(76) Inventors: Yoshiaki Nagara, Kariya-shi (JP); Kazunori Kitamura, Kariya-shi (JP); Yoshifumi Fujita, Kariya-shi (JP); Hiromu Iwata, Kariya-shi (JP); Takeshi Yamaguchi, Kariya-shi (JP); Yoshifumi Kato, Kariya-shi (JP)

Correspondence Address: MORGAN & FINNEGAN, L.L.P., 3 World Financial Center, New York, NY, 10281-2101, US

(21) Appl. No.: 11/707,316

(22) Filed: Feb. 16, 2007

(30) Foreign Application Priority Data
Feb. 16, 2006 (JP) 2006-039877
Sep. 27, 2006 (JP) 2006-262394

(51) Int. Cl. H01J 1/62

(52) U.S. Cl. 313/512; 313/504; 313/498

(57) ABSTRACT

An organic electroluminescent display panel includes a substrate, a plurality of first electrodes forming parallel stripes on the substrate, a plurality of electrical insulating partitions intersecting the first electrodes, an organic electroluminescent layer formed on the first electrodes and the partitions, a plurality of second electrodes located on the organic electroluminescent layer, and a sealing film. The second electrodes form stripes parallel with the partitions. An organic electroluminescent element is formed at each intersection of the first and second electrodes. The sealing film covers exposed portions of the first electrodes, the organic electroluminescent layer, the partitions, and the second electrodes. Each partition has an inverse tapered portion with a widened distal end. The angle θ defined by each tapered surface of the inverse tapered portion and a plane parallel with the substrate is in a range between 50 degrees and 80 degrees, inclusive, and the height H of the partitions is in a range between 1.5 μm and 6.0 μm, inclusive. The sealing film is formed of silicon nitride, and its thickness is in a range between 0.7 μm and 4.0 μm, inclusive.

### BACKGROUND OF THE INVENTION

The present invention relates to an organic electroluminescent display panel (hereafter, organic electroluminescence will be referred to as organic EL as necessary), and more particularly, to an organic electroluminescent display panel of a passive matrix type.

A typical organic EL display panel has first electrodes (anodes), second electrodes (cathodes), and an organic EL layer provided between the first electrodes and the second electrodes. When forming a passive matrix organic EL display panel, second electrodes need to be formed stripes extending perpendicular to first electrodes after forming an organic EL layer. To ensure that adjacent second electrodes are insulated from each other, partitions extending parallel to the second electrodes are provided.

For example, as disclosed in Japanese Laid-Open Patent Publication No. 8-315981, partitions having an inverse tapered shape are formed to extend in a direction perpendicular to first electrodes in parallel on a substrate, thereby ensuring that second electrodes formed on an organic EL layer are insulated from each other and from the first electrodes.

Since organic EL material is easily affected by water and oxygen, organic EL elements need to be sealed.

Conventionally, to seal organic EL elements, glass or stainless-steel sealing cans (cover cases) are used. However, a sealing can significantly increases the thickness of an organic EL display panel, and thus does not allow the display panel to be thin. Accordingly, when an organic EL display panel needs to be thin, sealing is achieved by an inorganic film.

The above-mentioned Japanese publication discloses a method in which, after forming second electrodes, an insulative sealing film is formed on a substrate while causing the substrate to rotate and orbit, using a method permitting material to enter spaces behind structures, such as deposition, sputtering or CVD method. The publication also discloses an example in which the height of partitions is 5.6 μm, the angle formed by the tapered surface of the partitions and the normal to the substrate is 30 degrees, and the insulative sealing film is made of SiO₂ and has a thickness of 1 μm.

Partitions function to separate the second electrodes from each other. The higher the partitions, the more reliably the second electrodes are separated from each other. However, the sealing film is not readily deposited on portions blocked by the partitions. This degrades the sealing performance. On the other hand, the lower the partitions, the more improved the sealing performance becomes. However, the separation of the second electrodes tends to be insufficient. Also, the smaller the angle defined by the tapered surface of each partition and a plane parallel to the substrate, the more reliably the second electrodes are separated. However, the proximal end of each partition becomes narrow, which reduces the strength of the partitions.

In the case where a sealing film is used to reduce the thickness of an organic EL display panel, it is difficult, due to the existence of the partitions, to form a sealing film having a uniform thickness on the organic EL elements. If the thickness of the sealing film is thin, unevenness of the thickness results in an insufficient sealing performance in thinner sections. The thicker the sealing film, the more improved the sealing performance for protecting the organic EL material from water and oxygen becomes. However, when the sealing film is thickened, stress of the sealing film causes the organic EL layer to be peeled off the electrodes (electrode layer). In addition, the manufacturing costs are increased.

Japanese Laid-Open Patent Publication No. 8-315981 discloses the formation of a sealing film of SiO₂ through a method that allows sealing material to enter spaces behind structures, in such a manner that the film has a thickness of 1 μm. However, the publication discloses no detailed description regarding the sealing film.

### SUMMARY OF THE INVENTION

Accordingly, it is an objective of the present invention to provide an organic EL display panel of passive matrix type that reliably separates second electrodes from each other and has an increased durability.

In accordance with one aspect of the present invention, an organic electroluminescent display panel including a substrate, a plurality of first electrodes forming parallel stripes on the substrate, a plurality of electrical insulating partitions intersecting the first electrodes, an organic electroluminescent layer formed on the first electrodes and the partitions, a plurality of second electrodes located on the organic electroluminescent layer, and a sealing film is provided. The second electrodes form stripes parallel with the partitions. An organic electroluminescent element is formed at each intersection of the first and second electrodes. The sealing film covers exposed portions of the first electrodes, the organic electroluminescent layer, the partitions, and the second electrodes. Each partition has an inverse tapered portion with a widened distal end. The angle θ defined by each tapered surface of the inverse tapered portion and a plane parallel with the substrate is in a range between 50 degrees and 80 degrees, inclusive, and the height H of the partitions is in a range between 1.5 μm and 6.0 μm, inclusive. The sealing film is formed of silicon nitride, and its thickness is in a range between 0.7 μm and 4.0 μm, inclusive.

### BRIEF DESCRIPTION OF THE DRAWINGS

FIG. 1A is a partial perspective view illustrating an organic EL display panel according to one embodiment;

FIG. 1B is a partial cross-sectional view illustrating the organic EL display panel shown in FIG. 1A; and

FIGS. 2A to 2C are partial cross-sectional views showing a procedure for manufacturing the organic EL display panel.

### DETAILED DESCRIPTION OF THE PREFERRED EMBODIMENTS

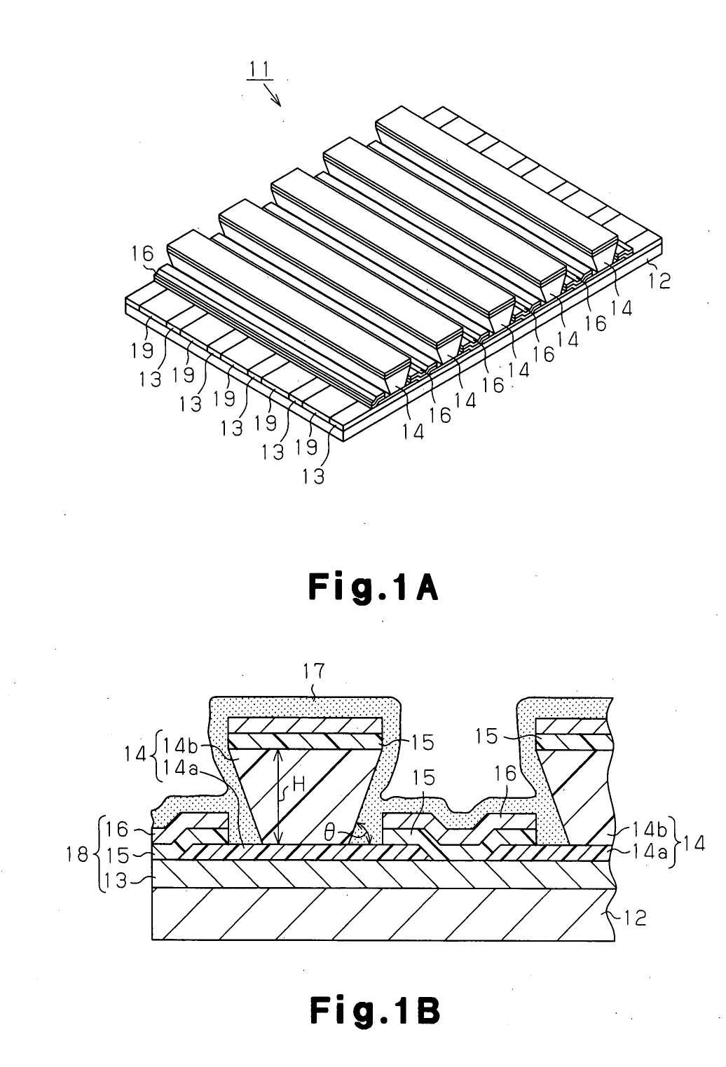

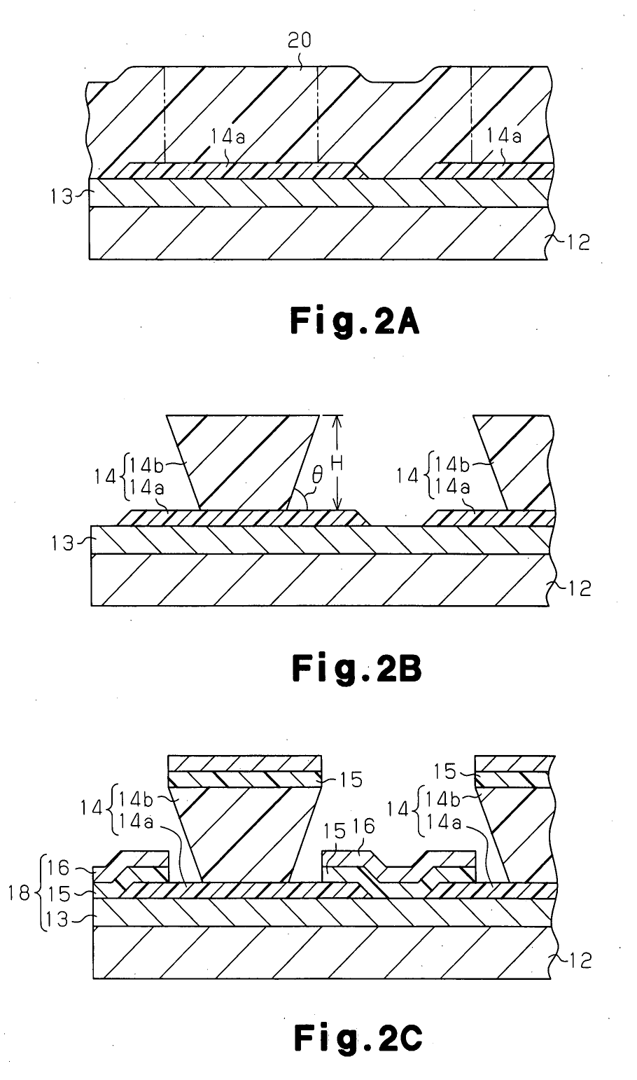

One embodiment of the present invention will now be described with reference to FIGS. 1A to 2C. Each of the FIGS. 1A to 2C schematically shows the structure of an organic EL display panel. For the illustrative purposes, the dimensions of some of the elements are exaggerated. That is, the ratios of the widths, lengths, and thicknesses of some of the elements in the drawings are not to scale.

FIG. 1A is a schematic perspective view illustrating an organic EL display panel from which a sealing film is omitted. As shown in FIGS. 1A and 1B, an organic EL display panel 11 has a substrate 12, first electrodes 13, partitions 14, and organic electroluminescent (EL) layers 15. The first electrodes 13 are formed on the substrate 12 to form stripes. The partitions 14 intersect the first electrodes 13. Each organic EL layer 15 is provided on one of the first electrodes 13. The organic EL display panel 11 also has second electrodes 16 and a sealing film 17. The second electrodes 16 are located on the organic EL layers 15 and parallel to the partitions 14. At each intersection of the first electrodes 13 and the second electrodes 16, an organic EL layer 15 is provided between the electrodes 13 and 16. Each of these stacked sections of the first electrodes 13, the second electrodes 16, and the organic EL layers 15 form an organic electroluminescent (EL) element 18. The organic EL display panel 11 includes the organic EL elements 18 arranged in matrix on the substrate 12.

A transparent glass substrate is used as the substrate 12.

The first electrodes 13 form anodes, and are formed of indium tin oxide (ITO), which is used for a transparent electrode in conventional organic EL elements. An insulating film 19 having substantially the same thickness as the first electrode 13 is provided between each adjacent pair of the first electrodes 13. The first electrodes 13 and the insulating films 19 are substantially flush with each other. In this embodiment, the width of the insulating film 19 is greater than the width of the first electrodes 13. For example, the ratio of the width of the insulating film 19 to the width of the first electrode 13 is set to be 5:3. The insulating films 19 are formed of positive resist.

Each partition 14 has a base 14a and an inverse tapered portion 14b. The base 14a extends perpendicular to the first electrodes 13, and the inverse tapered portion 14b is formed on the base 14a. The width of an inverse tapered portion 14b widens toward the distal end. The base 14a has a greater width than the width of the distal end of the inverse tapered portion 14b. The ratio of the width of the distal end of the inverse tapered portion 14b to the width of the base 14a is set to 3:5. The partitions 14 are formed such that the space between each adjacent pair of the inverse tapered portions 14b is several times the width of the distal end of the inverse tapered portion 14b. The bases 14a of the partitions 14 are formed of positive resist. The inverse tapered portions 14b are formed of negative resist.

The partitions 14 are formed such that an angle θ defined by each tapered surface of each inverse tapered portion 14b and a plane parallel to the substrate is in a range between 50 degrees and 80 degrees, inclusive, preferably in a range between 60 degrees and 70 degrees, inclusive, and more preferably equal to 65 degrees. Also, the partitions 14 are formed such that the height H of each inverse tapered portion 14b is in a range between 1.5 μm and 6.0 μm, inclusive, preferably in a range between 2.0 μm and 4.5 μm, inclusive, and more preferably in a range between 2.9 μm and 4.0 μm, inclusive.

Each organic EL layer 15 is formed by laminating a hole injection layer, a hole transport layer, a light emitting layer, an electron transport layer, and an electron injection layer in this order from the side next to the first electrode 13.

The second electrodes 16 form cathodes and are made of a metal suitable for cathodes of organic EL elements, for example, aluminum. The second electrodes 16 also reflect light. That is, each organic EL element 18 is a “bottom emission type”, in which light from the organic EL layer 15 is extracted through (exits) the substrate 12.

The sealing film 17 is formed to cover the exposed portions of the first electrodes 13, the organic EL layers 15, the partitions 14, and the second electrodes 16, that is, to cover exposed portions prior to the formation of the sealing film 17. However, the sealing film 17 is not formed on terminal sections of the first electrodes 13 and the second electrodes 16. The sealing film 17 is formed of silicon nitride, and its thickness is in a range between 0.7 μm and 4.0 μm, inclusive, preferably in a range between 1.2 μm and 3.0 μm, inclusive, and more preferably in a range between 1.5 μm and 2.0 μm, inclusive. Since the partitions 14 are formed on a side of the substrate 12 on which the sealing film 17 is formed, the thickness of the sealing film 17 varies according to location. Thus, in this specification, the thickness of the sealing film 17 refers to the thickness of a section of the sealing film 17 that is parallel to the substrate 12.

A method for manufacturing the organic EL display panel 11 will now be described.

First, in a patterning process, an ITO film serving as a transparent electrode is formed on the substrate 12. The ITO film is formed by a conventional method for forming thin films, such as sputtering, vacuum deposition, and ionized deposition. Then, the ITO film is etched to form stripes of the first electrodes 13.

Next, the insulating films 19 are formed to fill the gaps between the first electrodes 13. The insulating films 19 are formed through photolithography using a positive resist.

In a subsequent partition forming process, the partitions 14 are formed. The partition forming process includes a base forming process for forming the bases 14a, and an inverse tapered portion forming process for forming the inverse tapered portions 14b. In the base forming process, the bases 14a are formed through photolithography using a positive resist such that the bases 14a extend perpendicular to the first electrodes 13 and the insulating films 19. Specifically, after applying a positive resist through spin coating, the positive resist is heated by a hot plate. Then, the positive resist is irradiated with ultraviolet light except for sections that will become the bases 14a. Thereafter, the bases 14a are formed by developing. The bases 14a are then baked.

Next, in the inverse tapered portion forming process, the inverse tapered portions 14b are formed on the bases 14a through photolithography using a negative resist. First, as shown in FIG. 2A, a negative resist 20 is applied to cover the bases 14a and the first electrodes 13 through spin coating to have predetermined thickness. The applied negative resist 20 is temporarily cured by a hot plate. The height H of the inverse tapered portions 14b can be adjusted by changing the rotational speed of the spin coater during the spin coating. Then, sections that correspond to the width of the distal ends of the inverse tapered portions 14b are exposed to ultraviolet light, and developed. The negative resist 20 is cured faster in portions closer to the surface exposed to light. Therefore, even if the ultraviolet light is irradiated along a direction perpendicular to the negative resist 20, the development causes the inverse tapered portions 14b as shown in FIG. 2B to be formed on the bases 14a. After the development, the negative resist 20 is baked in the baking furnace. The angle θ of the inverse tapered portions 14b can be adjusted by changing the baking temperature.

After subjecting the substrate 12 to UV/ozone cleaning, the organic EL layers 15 are formed through an organic EL layer forming process. The organic EL layers 15 are formed by consecutively forming layers constituting the organic EL layers 15 through a known vacuum deposition. The thickness of each constituent layer is in a range between 1 to 100 nm, inclusive.

Next, in a second electrode forming process, the second electrodes 16, which cover the organic EL layers 15, are formed as stripes perpendicular to the first electrodes 13. The second electrodes 16 are formed by depositing aluminum (Al). The result is shown in FIG. 2C.

In a subsequent sealing film forming process, the sealing film 17 is formed. After the second electrodes 16 are formed, the sealing film 17 is formed by depositing silicon nitride through a known plasma CVD method, which is an integrated process performed in vacuum. The thickness of the sealing film 17 can be adjusted by controlling the depositing time of the plasma CVD.

### EXAMPLES

The present invention will now be described with reference to examples.

Organic EL display panels 11 for evaluation were prepared in the following basic conditions by using, as substrates 12, alkali-free glass plates having a size of 200 mm×200 mm and a thickness of 0.5 mm. The width of the first electrodes 13 was 15 μm and the thickness of the first electrodes 13 was 200 nm. The width of the insulating film 19 was 25 μm. The width of the bases 14a of the partitions 14 was 25 μm and the thickness of the bases 14a was 1 μm. The width of the distal ends of the inverse tapered portions 14b was 15 μm. The interval between the partitions 14 was 60 μm. The thickness of the second electrodes 16 was 150 nm. The organic EL layers 15 had the following composition.

As a hole injection layer, a layer of copper phthalocyanine (CuPc) having a thickness of 100 nm was used and, as a hole transport layer, a layer of diphenyl naphthyl diamine (NPD) having a thickness of 200 nm was used. A light emitting layer containing Alq3 as a host material and DCJTB as a dopant was formed to have a thickness of 30 nm. The amount of DCJTB was adjusted to be 2 wt % relative to the amount of Alq3. An Alq3 layer having a thickness of 20 nm was formed as an electron transport layer and a lithium fluoride (LiF) layer having a thickness of 1 nm was formed as an electron injection layer.

The height H of the inverse tapered portions 14b was varied in a range between 1.3 μm and 6.5 μm, inclusive, and the angle θ was varied in a range between 40 degrees and 85 degrees, inclusive. The thickness of the sealing films 17 was varied in a range between 0.5 μm and 5.0 μm, inclusive. In this manner, samples (organic EL display panel 11) of various combinations of the conditions were prepared, and the separation and sealing properties of the second electrode (cathode) were evaluated. The height H of the partitions 14, the angle θ, and the thickness of the sealing films 17 were measured through cross-section observation of the organic EL display panels 11.

The relationship between the rotational speed of the spin coater when applying the negative resist solution and the thickness of a resultant film had been obtained through tests, and then a desired height H of the inverse tapered portions 14b was obtained by driving the spin coater at a rotational speed corresponding to the desired height H. The relationship between the amount of exposure, the post baking temperature and time, and the angle θ had been obtained through tests, and then a desired angle θ of the inverse tapered portions 14b was obtained by performing exposure at an amount of exposure and post baking in post baking conditions corresponding to the desired angle θ. The relationship between the deposition time of the plasma CVD and the thickness of the formed film had been obtained through tests, and then a desired thickness of the sealing film 17 was obtained by performing plasma CVD for a deposition time corresponding to the desired thickness.

### Evaluation of Separation of Cathodes

The separation of the cathodes was evaluated by checking whether adjacent second electrodes 16 are electrically continuous. Specifically, all the first electrodes 13 were connected to the positive terminal of a power source, and the second electrodes 16 were connected to the negative terminal one by one. At this time, whether the organic EL layers 15 were capable of emitting light was checked. The case where the ratio (percentage) of second electrodes 16 that were electrically continuous with an adjacent second electrode 16 was 30% or more was denoted by ×, the case where the ratio was less than 30% and over 10% was denoted by Δ, and the case where the ratio was no greater than 10% was denoted by ◯.

### Evaluation of Sealing Performance

After leaving the samples of the organic EL display panels in a temperature of 60° C. and a relative humidity of 90% for 500 hours, a light emitting test was performed, and the ratio (percentage) of a light emitting area to the area of the all the pixels were obtained. The case where the light emitting ratio was not more than 60% was denoted by ×, the case where the ratio was more than 60% and less than 90% was denoted by Δ, and the case where the ratio was no less than 90% was denoted by ◯.

The results of the evaluations are shown in tables 1, 2 and 3.

TABLE 1

| | | Sealing | | |
|---|---|---|---|---|
| | | Film | | |
| Height H | Angle θ | Thickness | Separation | Sealing |
| (μm) | (degrees) | (μm) | of Cathodes | Performance |
| 1.3 | 60 | 1.8 | x | ∘ |
| 1.5 | 60 | 1.8 | Δ | ∘ |
| 2.0 | 60 | 1.8 | ∘ | ∘ |
| 2.9 | 60 | 1.8 | ∘ | ∘ |
| 3.6 | 60 | 1.8 | ∘ | ∘ |
| 4.0 | 60 | 1.8 | ∘ | ∘ |
| 4.5 | 60 | 1.8 | ∘ | ∘ |
| 6.0 | 60 | 1.8 | ∘ | Δ |
| 6.5 | 60 | 1.8 | ∘ | x |

TABLE 2

| | | Sealing | | |
|---|---|---|---|---|
| | | Film | | |
| Height H | Angle θ | Thickness | Separation | Sealing |
| (μm) | (degrees) | (μm) | of Cathodes | Performance |
| 2.9 | 40 | 1.8 | ∘ | x |
| 2.9 | 50 | 1.8 | ∘ | Δ |
| 2.9 | 60 | 1.8 | ∘ | ∘ |
| 2.9 | 65 | 1.8 | ∘ | ∘ |
| 2.9 | 70 | 1.8 | ∘ | ∘ |
| 2.9 | 80 | 1.8 | Δ | ∘ |
| 2.9 | 85 | 1.8 | x | ∘ |

The same results were obtained when the thickness of the sealing film was 3.6 μm.

TABLE 3

| | | Sealing | | |
|---|---|---|---|---|
| | | Film | | |
| Height H | Angle θ | Thickness | Separation | Sealing |
| (μm) | (degrees) | (μm) | of Cathodes | Performance |
| 2.9 | 60 | 0.5 | ∘ | x |
| 2.9 | 60 | 0.7 | ∘ | Δ |
| 2.9 | 60 | 1.2 | ∘ | ∘ |
| 2.9 | 60 | 1.5 | ∘ | ∘ |
| 2.9 | 60 | 1.8 | ∘ | ∘ |
| 2.9 | 60 | 2.5 | ∘ | ∘ |
| 2.9 | 60 | 3.0 | ∘ | ∘ |
| 2.9 | 60 | 4.0 | ∘ | ∘ |
| 2.9 | 60 | 5.0 | ∘ | ∘* |

*Peeling occurred at the interface between the organic EL layer and the electrodes

The same results were obtained when the angle θ was 65 degrees.

As shown in Table 1, the evaluation of cathode separation was × when the height of the inverse tapered portions 14b was 1.3 μm, Δ when the height H was 1.5 μm, and ◯ when the height H was in a range between 2.0 μm and 6.5 μm, inclusive. The evaluation of sealing performance was ◯ when the height of the inverse tapered portions 14b was 6.5 μm, Δ when the height H was 6.0 μm, and ◯ when the height H was in a range between 1.3 μm and 4.5 μm, inclusive.

The samples that obtained the evaluation of × were failures. The samples of the evaluation of Δ have poorer yields than the samples of the evaluation of ◯, but are not failures. Based on the evaluations of the cathode separation and the sealing performance, the height H of the inverse tapered portions 14b should be in a range between 1.5 μm and 6.0 μm, inclusive, and is preferably in a range between 2.0 μm and 4.5 μm, inclusive, and more preferably in a range between 2.9 μm and 4.0 μm, inclusive.

As shown in Table 2, the evaluation of cathode separation was × when the angle θ of the inverse tapered portions 14b was 85 degrees, Δ when the angle θ was 80 degrees, and ◯ when the angle θ was in a range between 40 degrees and 70 degrees, inclusive. The evaluation of sealing performance was × when the angle θ of the inverse tapered portions 14b was 40 degrees, Δ when the angle Δ was 50 degrees, and ◯ when the angle θ was in a range between 60 degrees and 85 degrees, inclusive. The samples that obtained the evaluation of × were failures. The samples of the evaluation of Δ have poorer yields than the samples of the evaluation of ◯, but are not failures. The angle θ of the inverse tapered portions 14b should to be in a range between 50 degrees and 80 degrees, inclusive, and is preferably in a range between 60 degrees and 70 degrees.

As shown in Table 3, the evaluation of the cathode separation was ◯ as long as the thickness of the sealing film 17 was in a range between 0.5 μm and 5.0 μm. The evaluation of sealing performance was × when the thickness of the sealing film 17 was 0.5 μm, Δ when the thickness was 0.7 μm, and ◯ when the thickness was in a range between 1.2 μm and 5.0 μm, inclusive. When the film thickness is 5.0 μm, observation of sections that did not emit light revealed that these non-light emitting sections were not “dark spots”, which are the result of poor sealing performance. Thus, it is believed that these sections were created by exfoliations at the interface between the organic EL layer 15 and the first electrodes 13 or at the interface between the organic EL layer 15 and the second electrode 16. Therefore, the samples with a sealing film 17 having a thickness of 5.0 μm were acceptable with respect to the sealing performance, but rejected because of insufficient moisture exclusion for the organic EL elements 18. Accordingly, the thickness of the sealing film 17 should be in a range between 0.7 μm and 4.0 μm, inclusive, preferably in a range between 1.2 μm and 3.0 μm, inclusive, and more preferably in a range between 1.5 μm and 2.0 μm, inclusive.

The present embodiment has the following advantages.

The organic EL display panel 11 has the first electrodes 13, the partitions 14, the organic EL layers 15, and the second electrodes 16. The first electrodes 13 are formed on the substrate 12 to form parallel stripes. The partitions 14 are insulative and intersect the first electrodes 13. The organic EL layers 15 are formed on the first electrodes 13 and the partitions 14. The second electrodes 16 are located on the organic EL layers 15 and form stripes parallel to the partitions 14. The first electrodes 13, the organic EL layers 15, the partitions 14, and the second electrodes 16 are sealed by the sealing film 17. Each partition 14 is formed to have an inverse tapered portion 14b with a wide distal end. The angle θ defined by each tapered surface of the inverse tapered portion 14b and a plane parallel to the substrate 12 is in a range between 50 degrees and 80 degrees, inclusive. The height H of the inverse tapered portions 14b is in a range between 1.5 μm and 6.0 μm, inclusive. The sealing film 17 is made of silicon nitride to have a thickness in a range between 0.7 μm and 4.0 μm, inclusive. Thus, a passive matrix organic EL display panel 11 having a good separation of second electrodes and durability is obtained. Since the silicon nitride forming the sealing film 17 has a density 1.4 times the density of silicon dioxide and is closely packed, the sealing film 17 hardly transmits water and oxygen. Thus, compared to a case in which the sealing film 17 is made of silicon dioxide, the illustrated embodiment allows the sealing film 17 to have a better sealing performance for the same film thickness.

Each partition 14 has a base 14a and an inverse tapered portion 14b. The base 14a intersects the first electrodes 13. The inverse tapered portion 14b is formed on the base 14a and the width of the distal end of the inverse tapered portion 14b is less than the width of the base 14a. In this manner, the inverse tapered portions 14b are not directly formed on the first electrodes 13, but are formed on the bases 14a, the width of which is greater than the width of the distal end of the inverse tapered portions 14b.

When the height of the partitions 14 is in the range between 2 μm and 4.5 μm, inclusive, the separation of the second electrodes and the sealing performance are improved.

When the angle θ of the partitions 14 is in the range between 60 degrees and 70 degrees, inclusive, the separation of the second electrodes and the sealing performance are improved.

When the thickness of the sealing film is in the range between 1.2 μm and 4.0 μm, inclusive, the sealing performance is improved.

It should be apparent to those skilled in the art that the present invention may be embodied in many other specific forms without departing from the spirit or scope of the invention. Particularly, it should be understood that the invention may be embodied in the following forms.

The insulating films 19 and the bases 14a may be made of a negative resist instead of a positive resist. When using a negative resist, the same negative resist used for forming the inverse tapered portion 14b may be used for forming the insulating films 19 and the bases 14a.

The bases 14a may be omitted so that each partition 14 has an inverse tapered portion 14b only. In this case, an insulating film separated from the partitions 14 needs to be provided about the proximal end of the inverse tapered portion 14b, so that a short circuit between the second electrodes 16 and the first electrodes 13 is prevented.

The size of the substrate 12, the width of the first electrodes 13, the width of the insulating films 19, the width and thickness of the bases 14a of the partitions 14, the width of the distal ends of the inverse tapered portions 14b, the space between adjacent partitions 14, and the thickness of the second electrodes 16 may be changed as necessary.

As long as the first electrodes 13 and the second electrodes 16 intersect, the electrodes 13, 16 do not need to be perpendicular to each other.

In order to adjust the angle θ of the inverse tapered portions 14b of the partitions 14 to be a desired value, the exposure time or the angle of exposure may be adjusted instead of adjusting the post-baking temperature.

The organic EL layers 15 do not need to be constructed to have a hole injection layer, a hole transport layer, a light emitting layer, an electron transport layer, and an electron injection layer as long as a light emitting layer is included. For example, the organic EL layers 15 may have a three-layer structure with a hole transport layer, a light emitting layer, and an electron transport layer or a three-layer structure with a hole injection transport layer, a light emitting layer, and an electron injection transport layer. Alternatively, depending on the material for the light emitting layer, the organic EL layers 15 may be formed solely of the light emitting layer.

The organic EL display panel 11 is not limited to a mono color display, but may be applied to an area color display of several colors, or a full color display. In a case of full color display, for example, a substrate formed by forming a resin overcoat layer on a surface of a color filter is used as the substrate 12. In this case, the first electrodes 13, the insulating films 19, the partitions 14, the organic EL layer 15, and the second electrodes 16 are formed on the overcoat layer.

The organic EL layers 15 may be designed to emit white light. Emission of the white light may be accomplished by providing a blue light emitting layer, a green light emitting layer, and a red light emitting layer in such a manner as to the layers overlap. Also, emission of the white light may be accomplished by forming stripes of alternately arranged blue light emitting layers, green light emitting layers, and red light emitting layers. Alternatively, organic light emitting materials that emit red light, green light, and blue light may be mixed in a single light emitting layer.

The substrate 12 does not need to be made of glass, but may be made of transparent resin or film.

The transparent electrode forming the first electrodes 13 does not need to be made of ITO, but may be made of indium zinc oxide (IZO), zinc oxide (ZnO), or tin oxide (SnO₂).

The second electrodes 16 do not need to be made of aluminum, but may be made of known cathode materials. For example, the second electrodes 16 may be made of gold, silver, copper, chromium, or an alloy of these metals.

The second electrodes 16 do not need to be designed to reflect light.

The organic EL elements 18 do not need to have a configuration to emit light through the substrate 12. Instead, the organic EL elements 18 may be top emission type organic EL elements that emit light from a side opposite from the substrate 12. In this case, the second electrode 16, which second electrode 16 is located on the opposite side of the organic EL layer 15 to the substrate 12, is made of a transparent electrode in each organic EL element 18. Since the work function on a surface of an ITO film has a value suitable for injection of holes, an ITO film is suitable for forming an anode, but is not most suitable for forming a cathode. Thus, if an electrode forming a cathode of the organic EL element is made of ITO so that the electrode becomes transparent, it is preferable to provide, on a surface facing the organic EL layer 15 made of ITO, a metal film that is sufficiently thin to be transparent.

In the case where the organic EL element 18 is a top emission type, the first electrodes 13 provided on the substrate 12 do not need to be transparent.

What is claimed is:

1. An organic electroluminescent display panel comprising:
a substrate;
a plurality of first electrodes forming parallel stripes on the substrate;
a plurality of electrical insulating partitions intersecting the first electrodes;
an organic electroluminescent layer formed on the first electrodes and the partitions;
a plurality of second electrodes located on the organic electroluminescent layer, the second electrodes forming stripes parallel with the partitions, wherein an organic electroluminescent element is formed at each intersection of the first and second electrodes, the organic electroluminescent elements forming a matrix; and
a sealing film covering exposed portions of the first electrodes, the organic electroluminescent layer, the partitions, and the second electrodes,
wherein each partition has an inverse tapered portion with a widened distal end, wherein the angle θ defined by each tapered surface of the inverse tapered portion and a plane parallel with the substrate is in a range between 50 degrees and 80 degrees, inclusive, and the height H of the partitions is in a range between 1.5 μm and 6.0 μm, inclusive, and
wherein the sealing film is formed of silicon nitride, and its thickness is in a range between 0.7 μm and 4.0 μm, inclusive.

2. The organic electroluminescent display panel according to claim 1, wherein each partition has a base that intersects the first electrodes, each inverse tapered portion being formed on the corresponding base, and the width of the distal end of the inverse tapered portions is smaller than the width of the bases.

3. The organic electroluminescent display panel according to claim 1, wherein the height H of the partitions is in a range between 2 μm and 4.5 μm, inclusive.

4. The organic electroluminescent display panel according to claim 1, wherein the angle θ of the partitions is in a range between 60 degrees and 70 degrees, inclusive.

5. The organic electroluminescent display panel according to claim 1, wherein the thickness of the sealing film is less than or equal to 1.2 μm.
